(19) United States
(12) Patent Application Publication
(10) Pub. No.: US 2002/0182573 A1
(43) Pub. Date: Dec. 5, 2002

(54) Education methods and systems based on behavioral profiles

(76) Inventor: John B. Watson, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/158,329

(22) Filed: May 28, 2002

Related U.S. Application Data
(60) Provisional application No. 60/294,134, filed on May 29, 2001.

(51) Int. Cl. G09B 19/00

(52) U.S. Cl. 434/236

(57) ABSTRACT

The invention relates to a teaching system that includes a module for creating and using behavioral profiles of students. The behavioral profile is developed by capturing and processing passive data from the student's computer as they are studying an on-line lesson or taking a test (assessment). In addition, the behavioral profile of a specific student can be used for comparison against longitudinal behavioral profiles of other students in order to recommend learning resources or strategies to the specific student. The recommendation may be based on the similarities between the behavioral profile of the specific student and those of the longitudinal behavioral profile of the other students, and the effective learning resources or strategies associated with the longitudinal behavioral profiles of the other students.

### RELATED APPLICATIONS

This application claims priority from U.S. Provisional Application No. 60/294,134 filed on May 29, 2001, which is hereby incorporated in its entirety herein by reference.

### BACKGROUND OF THE INVENTION

1. Field of the Invention

Embodiments of the invention relate generally to computer-based educational systems. More particularly, embodiments of the invention concern teaching or learning methods and systems that collect input pertaining to a student's interaction with a multi-media presentation executing on a computing device or computer network, create a behavioral profile from this input, and use the behavioral profile to trigger predefined computer-based events or to determine suitable content of educational presentations, resources, or strategies for the student.

2. Description of the Related Art

Computers and computer-related technology have become important tools for teaching and learning. Educators now may rely on multi-media presentations as another avenue to promote learning and to assess student knowledge. Currently there is available a myriad of computer software applications designed to work as teaching tools for students of any age. Typically these applications are composed of a group of screen displays that present a lesson; the presentation may be enhanced with animation, sounds, and interactive elements. Sometimes the presentation is accompanied with a component that quizzes the student for understanding of the lesson. Commonly these applications present the same content and format regardless of the individual characteristics of the student.

A few computer-based teaching applications are configured to adapt the content or form of a presentation based on perceived characteristics of individual students. For example, U.S. Pat. No. 6,164,975 to Weingarden et al. (“Weingarden”), discloses a system that creates a profile of a student's “cognitive style and achievement level,” and uses the “cognitive profile” to adapt the presentation to the student's cognitive style and demonstrated ability. Weingarden creates the cognitive profile by presenting to the student one or more times the same lesson, each time utilizing different forms of presentation (e.g., more or less graphical, more or less audio output, more or less dynamic, etc.). For each time the lesson is presented, Weingarden tests the student and determines the level of comprehension of the student in the given multi-media environment. Weingarden assigns the multi-media environment that appears to be most closely associated with the student's higher level of comprehension as the student's “cognitive style” or “cognitive profile.” Thereafter, Weingarden presents to the student future lessons utilizing the multi-media environment that fits the student's cognitive profile.

Weingarden's method is cumbersome in that it requires multiple presentations of the same lesson in order to arrive at a “cognitive style” of the student. Also, Weingarden's method is susceptible to inaccurate assessment of the cognitive profile to the extent that the effect of presenting to the student the same lesson in different formats cannot be isolated from determining the student's comprehension of the lesson in any one specific format.

There is, therefore, a need in the relevant technology for simpler methods and systems for creating an accurate student profile. There is a need for a behavior-based student profile that educators and computer-based teaching systems can use to guide selection of content and form for presenting lessons to a student.

### SUMMARY OF THE INVENTION

The methods and systems of the present invention have several aspects, no single one of which is solely responsible for its desirable attributes. Without limiting the scope of this invention as expressed by the claims which follow, certain inventive embodiments will now be discussed briefly. After considering this discussion, and particularly after reading the section entitled “Detailed Description of the Preferred Embodiment” a person of ordinary skill in the relevant technology will understand how the features of this invention provide advantages in the creation of behavioral profiles and their use in an educational setting.

Some embodiments of the invention are directed to a method of creating a behavioral profile of a student in a computerized teaching system. The method may comprise displaying to the student a plurality of interactive computer screen displays associated with a lesson or a test. The method may further comprise receiving passive data from monitoring an input on the computer over a predetermined period of time, and determining an attribute of the student's learning ability based on the received passive data. The method may further comprise storing the determined attribute to a student behavioral profile to a storage associated with the teaching system.

Another aspect of the invention concerns a computerized teaching system comprising a computer having a display and an input. The system may comprise a computer monitor connected to the computer, wherein the monitor displays a plurality of interactive computer screens associated with a lesson or a test. The system may further comprise a first module configured to receive passive data by monitoring the input connected to the computer over a predetermined period of time, a second module configured to determine an attribute of the student's learning ability based on the received passive data; and a third module configured to store the determined attribute to a student behavioral profile to a storage associated with the teaching system.

Another inventive aspect of the invention is directed to a method of using a behavioral profile for adapting the content or form, or both, of a presentation. The method may comprise defining one or more behavioral profile classifications, wherein the classifications are associated with selected ones of a plurality of content and form resources of a presentation. The method may further comprise constructing a behavioral profile of a student, wherein the behavioral profile comprises a plurality of attributes, and wherein constructing comprises: displaying to the student a plurality of interactive screen displays associated with a lesson or a test, or both; receiving input from the student at a computing device, wherein the input comprises keyboard entries and pointer movement; determining a pointer movement pattern of the student and based thereon assigning a pointer movement attribute to the behavioral profile; determining an average time period that the student takes to answer questions presented to the student via the interactive screen displays, and based thereon assigning a response time attribute to the behavioral profile; determining a sequence of interactive screen displays chosen by the student while taking the lesson or test, or both, and based on the sequence assigning a navigational attribute to the behavioral profile; and storing the behavioral profile at a memory of the computing device. The method may further comprise associating at least one of the one or more behavioral profile classifications to the behavioral profile of the student; and selecting for display to the student one or more content or form resources associated with the profile classification corresponding to the behavioral profile of the student.

In one embodiment the invention consists of a method of selecting resources from a resource pool for presentation to a student. The method may comprise displaying to the student a plurality of questions, and receiving from the student a plurality of answers corresponding to the plurality of questions. The method may further comprise comparing the plurality of answers to an answer key, and determining a set of incorrect answers, and determining at least one deficiency of the student based on the set of incorrect answers. The method may further comprise selecting a resource from the resource pool based on the deficiency of the student; and displaying the resource to the student.

In another embodiment, the invention concerns a method of filtering the results of a web search to target the individual needs of a student. The method may comprise constructing a behavioral profile of the student. The method may further comprise receiving a plurality of results from a web search, and identifying selected ones of the plurality of results based on their compatibility with the behavioral profile of the student. The method may further comprise displaying to the student the selected results. In one embodiment, selecting a resource from the resource pool comprises retrieving selected ones of a plurality of results of a web search.

In yet another embodiment of the invention, there is provided a method of monitoring and managing the interaction of a student with a computer-based educational system. The method may comprise defining a plurality of thresholds associated with interaction of the student with the computer-based educational system, and defining a plurality of actions associated with the thresholds. The method may further comprise monitoring the interaction of the student with the computer-based educational system, wherein monitoring comprises keeping a record of a plurality of interactions of the student with the computer-based educational system. The method may further comprise comparing the record to the thresholds, and executing at least one of the actions when an element of the record matches at least one of the thresholds.

Another aspect of the invention concerns a method of establishing a measure of the metacognitive awareness level of a student. The method may comprise displaying a first set of screen displays to the student, wherein the first set of screen displays is associated with a lesson. The method may further comprise presenting a metacognitive probe to the student, and receive a response from the student to the metacognitive probe. The method may further comprise displaying a second set of screen displays to the student, wherein the second set of screens displays is associated with testing the student to determine the student's level of comprehension of the lesson. The method may further comprise comparing the response from the student to the metacognitive probe against the student's level of comprehension, and determining the metacognitive awareness level of the student based on the comparing. In some embodiments, the metacognitive awareness level is assigned as an attribute of a student's behavioral profile.

### BRIEF DESCRIPTION OF THE DRAWINGS

The above and other aspects, features, and advantages of the invention will be better understood by referring to the following detailed description, which should be read in conjunction with the accompanying drawings, in which:

FIG. 1 is a block diagram illustrating one embodiment of a teaching system.

FIG. 2 is a flow diagram illustrating one embodiment of a process for creating a student profile.

FIG. 3 is one embodiment of the receive and store demographic data process of FIG. 2.

FIG. 4 is one embodiment of a process for collecting passive data within the teaching system.

FIGS. 5A, 5B and 5C illustrate one embodiment of a process for compiling and storing individual profiles within the teaching system.

FIG. 6 illustrates one embodiment of a process for filtering Internet pages based on a student's profile.

FIG. 7 illustrates one embodiment of a process for analyzing Internet pages that are compared against a student's profile.

FIG. 8 illustrates one embodiment of a process for selecting and displaying educational resources to a student.

FIG. 9 illustrates one embodiment of a process for performing actions within a teaching system based on threshold conditions.

FIG. 10 illustrates one embodiment of a process for updating behavioral profiles within a teaching system.

FIG. 11 illustrates one embodiment of a process for associating a metacognitive awareness level value with an individual's profile.

### DETAILED DESCRIPTION OF THE PREFERRED EMBODIMENT

The following detailed description illustrates certain embodiments of the invention by way of example, not by way of limitation of the principles of the invention. This description will clearly enable one skilled in the art to make and use the invention, and describes several embodiments, adaptations, variations, alternatives and uses of the invention, including what we presently believe is the best mode of carrying out the invention.

A. Overview

Embodiments of the invention relate to methods and systems for use in education. In some embodiments, a teaching system according to the invention employs a computer network, e.g., the World Wide Web, for allowing teachers, parents, and/or students access to teaching resources, student lessons and/or assessments, or the like. The system provides educators, either teachers or parents or both, with methods and resources for providing highly personalized learning resources, strategies, or environments (such as a multimedia environment) to a student. In some embodiments, a student may access the system via the Internet, launch an educational application hosted on a web site, and take a lesson or a test assessment on any given subject, e.g., history, mathematics, art, etc. While the student is on-line interacting with the application, the system collects behavioral data from input or observation of the student. The behavioral data and other demographic data may be associated to construct a student profile. The student's teacher or the parent may also access the web site to monitor the progress of the student, to access the student's profile in order to determine the most suitable resources, strategies, or environments that maximize that particular student's learning, or to take other actions that may be suggested by the system based on the student's profile.

In one embodiment, educators (e.g., teachers or parents) use the system to create the behavioral profile of an individual student, and based on the behavioral profile to select the most appropriate resources to use in teaching that individual student. The system records the behavioral interaction of the student with a multi-media application executing on a computing device. The behavioral interaction may consist of student input to the system via input devices such as a pointing device (e.g., a “mouse”), keyboard, or microphone. Additionally, the system may collect behavioral data from “observation” of the student via video input or eye tracking.

The term “passive data” as used here refers to behavioral data, and other like data, collected from recording or observing the student's interaction with the system. In some embodiments, for example, “passive data” refers to input data that is not a direct response to a question or prompt from the teaching system. By way of illustration, an application may ask the student for the answer to the equation “7+14=.” The student may enter the answer “21” as a direct response to the question—this type of input would not be considered “passive data.” However, the student's mouse movements, oral expressions, eye movements, and the like, observed during the period of time that the student is presented with the question and provides an answer, may be referred to as “passive data.”

The input data is processed to determine a behavioral profile consisting of a number of attributes based on interpretation and classification of the behavioral data collected. One attribute may be, for example, the preference of input device, such as keyboard, mouse, or microphone. One feature of the system is that it need not explicitly ask the student for the student's preference; rather, the system passively collects data from the student—by collecting and interpreting behavioral input—and from the observation determines the student's preferences and other behavioral attributes. Another example of a behavioral attribute is “complexity of navigation,” which refers to the manner in which the student navigates through the group of screen displays comprising a lesson or test.

Based on the attributes of the behavioral profile for an individual student, the system and/or the educator chooses resources that are most suited for addressing the individual student's strengths and weaknesses. In one embodiment, the system uses the behavioral profile to filter out the least appropriate or relevant resources retrieved by a search of the World Wide Web (the “web”) performed by a search engine. In another embodiment, the system or educator may use the behavioral profile to select the most appropriate resources for the individual student from a predetermined pool of resources, which may be stored in a central data store. In another embodiment, the system uses the behavioral profile to determine the subject content or multi-media elements to use in constructing a screen display, such as a web browser page, for presenting a highly personalized lesson that is closely tailored to the student's needs. In still another embodiment, the system aggregates the behavioral profile data into a report, which the educator may use for individualized instruction beyond the computer system.

B. Definitions

Input Devices

An input device can be, for example, a keyboard, rollerball, mouse, voice recognition system or other device capable of transmitting information from a student to a computer. The input device can also be a touch screen associated with the display, in which case the student responds to prompts on the display by touching the screen. The student may enter textual information through the input device such as the keyboard, the mouse, or the touch-screen.

Instructions

As used here, the term “instructions” refers to computer-implemented steps for processing information in the system. Instructions may be implemented in software, firmware or hardware and include any type of programmed step undertaken by components of the system.

LAN

One example of a Local Area Network may be a corporate computing network, including access to the Internet, to which computers and computing devices comprising the system are connected. In one embodiment, the LAN conforms to the Transmission Control Protocol/Internet Protocol (TCP/IP) industry standard. In alternative embodiments, the LAN may conform to other network standards, including, but not limited to, the International Standards Organization's Open Systems Interconnection, IBM's SNA, Novell's Netware, and Banyan VINES.

Media

As used here, the term “media” refers to images, sounds, video or any other multimedia-type data that is entered into the preferred system. An example of media is an image of a document scanned into the system by a document scanner.

Microprocessor

As used here, the term “microprocessor” refers to any conventional general purpose single- or multi-chip microprocessor such as a Pentium processor, a Pentium® Pro processor, a 8051 processor, a MIPS® processor, a Power PC® processor, or an ALPHA® processor. In addition, the microprocessor may be any conventional special purpose microprocessor such as a digital signal processor or a graphics processor. The microprocessor typically has conventional address lines, conventional data lines, and one or more conventional control lines.

Modules

The system comprises various modules as discussed in detail below. As used here, and as can be appreciated by one of ordinary skill in the art, the term “module” comprises various sub-routines, procedures, definitional statements and macros. Each of the modules are typically separately compiled and linked into a single executable program. Therefore, the following description of each of the modules is used for convenience to describe the functionality of the preferred system. Thus, each of the modules may undergo one or more processes that may be arbitrarily redistributed to one of the other modules, combined together in a single module, or made available in, for example, a shareable dynamic link library.

Network

As used here, the term “network” means any type of electronically connected group of computers including, for instance, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). It will be apparent to a person of ordinary skill in the relevant technology that computing devices may be desktop, server, portable, hand-held, set-top, or any other desired type of configuration. As used here, an Internet includes network variations such as public internet, a private internet, a secure internet, a private network, a public network, a value-added network, an intranet, and the like.

Operating System

The system may be used in connection with various computer operating systems. Examples of operating systems such as: UNIX, Disk Operating System (DOS), OS/2, Windows 3.X, Windows 95, Windows 98, Windows NT, Windows XP, and Windows 2000.

Programming Language

The system may be implemented in any programming language such as C, C++, BASIC, Pascal, Java, and FORTRAN that run under most well-known operating systems. C, C++, BASIC, Pascal, Java, and FORTRAN are industry standard programming languages for which many commercial compilers can be used to create executable code. Other languages that may be used in the implementation of the system are scripting languages available for Internet-based delivery of the system like Macromedia Cold Fusion, Microsoft Active Server Pages or ‘.NET’, or PHP.

Transmission Control Protocol

As used here, the term “transmission Control Protocol” (TCP) means a transport layer protocol used to provide a reliable, connection-oriented, transport layer link among computer systems. The network layer provides services to the transport layer. Using a two-way handshaking scheme, TCP provides the mechanism for establishing, maintaining, and terminating logical connections among computer systems. TCP transport layer uses IP as its network layer protocol. Additionally, TCP provides protocol ports to distinguish multiple programs executing on a single device by including the destination and source port number with each message. TCP performs functions such as transmission of byte streams, data flow definitions, data acknowledgments, lost or corrupt data re-transmissions and multiplexing multiple connections through a single network connection. Finally, TCP is responsible for encapsulating information into a datagram structure.

Threshold Conditions/Threshold Actions

As used here, the term “threshold conditions” means a set of data comparison values that are compared to performance or behavioral profile data. If performance or behavioral profile data meets a specific threshold condition, then a preset “threshold action” may follow. A threshold action is a preset computer command that follows a threshold condition. A threshold condition may be, for example, that the total score of a student on a test is less than 30 percent. An example of a corresponding threshold action is that an electronic mail be sent to the educator reporting the student's score.

C. Certain Inventive Embodiments

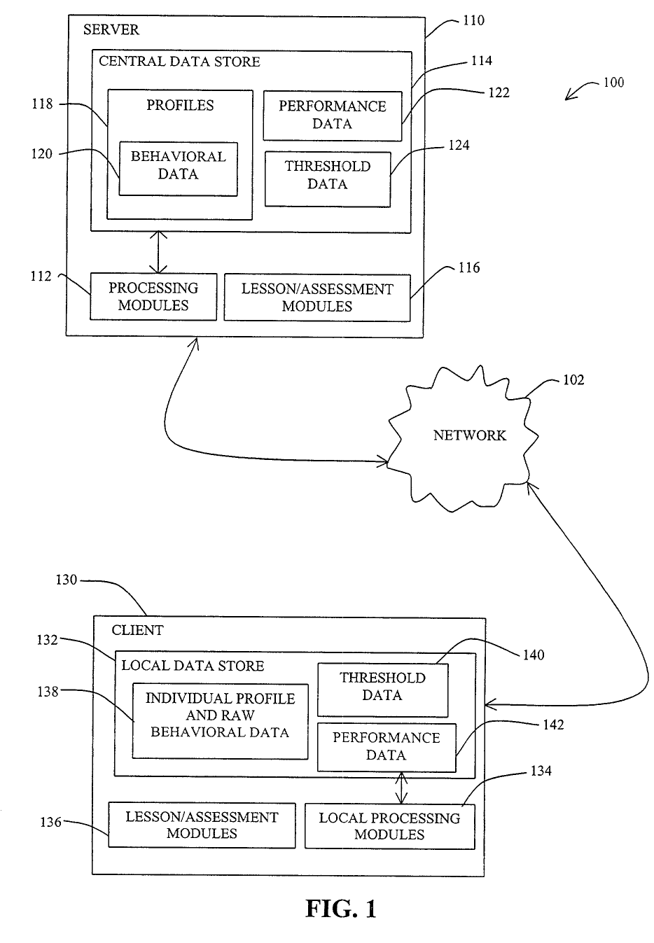

FIG. 1 illustrates one embodiment of a teaching system 100 that includes a network 102 connecting a server 110 to a client computer 130. The server 110 includes a central data store 114 for storing data within the teaching system 100. The central data store 114 preferably is based on a well-known database architecture such as those from Oracle, International Business Machines, or other database providers.

The central data store 114 includes a profiles module 118 that is associated with a student's behavioral data 120. The profiles module 118 includes student profiles for each student that is stored within the teaching system 100. For example, a student profile would include their name, address, grade level, teacher name, parent name and other information identifying the student within the teaching system 100. In addition, each student profile includes behavioral data 120 which is gathered from monitoring passive activity of the student during a teaching session. This will be explained in more detail below.

A central data store 114 also includes performance data 122 which is data associated with the student's scholastic profile. For example, performance data may include the student's grade for one or more subjects, or one or more assessments within a subject. The central data store 114 may also include; threshold data 124 which is one or more threshold conditions for triggering corresponding threshold actions by the system.

Communicating with the central data store 114 is a processing module 112 and lesson/assessment module 116. As illustrated, these modules and a server 110 communicate across a network 102 to a client computer 130. The network 102 can be any type of local area network, or wide area network such as those known in the art for linking a plurality of computer systems together.

As illustrated in FIG. 1, the client computer 130 includes a local data store 132 which holds individual profiles and raw behavioral data 138 relating to the individual student using the client computer 130. The local data store 132 also includes threshold data 140 and performance data 142.

The local data store 132 is linked to a local processing module 134 for processing data relating to the local data store. In addition, the client computer 130 includes a series of lesson/assessment modules which are presented to the student in order to teach and/or test a variety of subjects.

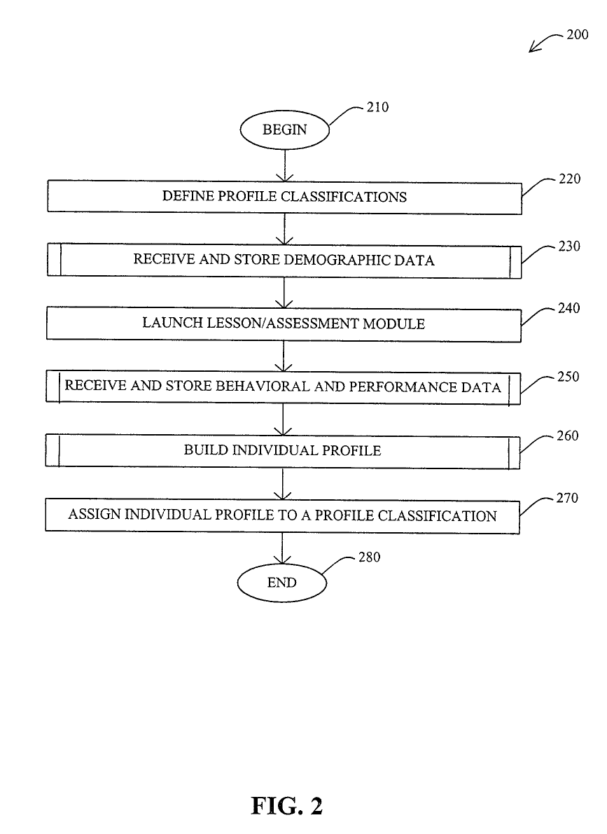

Referring now to FIG. 2, a process 200 for assigning individual student profiles to a profile classification. The process 200 begins at a start state 210 and moves to a state 220 wherein a series of profile classifications are defined. Many types of profile classifications may be defined, such as “complex navigator” or “simple navigator,” “metacognitively aware” or “metacognitively unaware” “audio preference” or “no audio preference.”

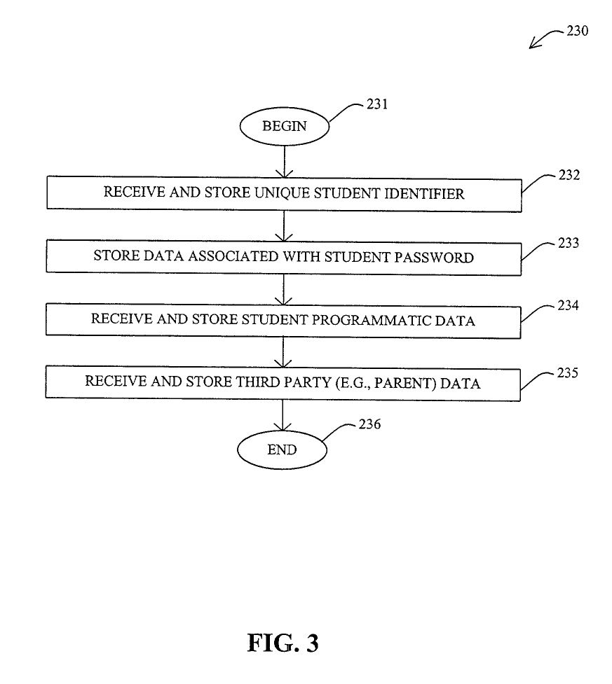

Once the profile classifications are defined at the state 220, the process 200 moves to a process state 230 wherein demographic data relating to the student is received and stored into the teaching system 100. This is explained more completely with regard to FIG. 3 below. Once the demographic data has been received and stored, the process 200 moves to a state 240 wherein a teaching lesson or assessment module is initiated for the student. As should be understood, each lesson is designed to teach a student one or more particular subjects while the assessment module is designed to test the student for their knowledge of each particular lesson. As the student is being taught the lesson, or is taking an assessment test, the process 200 moves to a process state 250 wherein behavioral and performance data is passively gathered from the student's interaction with the teaching system 100. The variety of mechanisms for receiving and storing behavioral and performance data is explained more completely with reference to the figures below.

Once a plurality of behavioral and performance data has been gathered at the process state 250, the process 200 moves to a process state 260 in order to build an individual profile for the student that is taking the current lesson. The individual profile, as described below, includes the behavioral and performance data gathered at the process state 250. In addition, the teaching system 100 generates generic rules based on the behavioral and performance data gathered at the process state 250. Thus, if the behavioral data indicates that the student answers questions more quickly when there are more graphics presented during the lesson, a generic rule can be created for the student's profile which reflects that they learn more efficiently if taught using graphical images.

Once an individual profile has been built at the process state 260, the process 200 moves to a state 270 wherein the individual profile is assigned one or more profile classifications. The process 200 then terminates at an end state 280.

Referring now to FIG. 3, the process 230 of receiving and storing demographic data (FIG. 2) is explained more specifically. The process 230 begins at a start state 231 and then moves to a state 232 wherein a unique student's identifier is received and stored by the teaching system 100. The process 230 then moves to a state 233 wherein data associated with the student's password is stored to the system 100. The process 230 then moves to a state 234 wherein the student's programmatic data is received and stored in the system. Next, at a state 235, any third party data, such as from a student's parents, is received and stored into the teaching system 100. The process 230 then terminates at an end state 236.

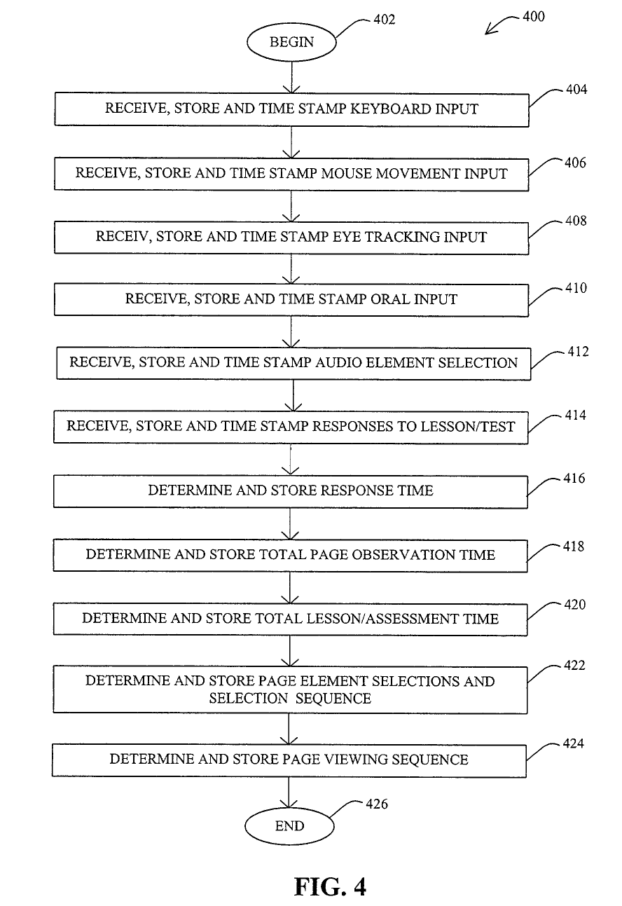

FIG. 4 illustrates one embodiment of a process for retrieving passive data from a student during a lesson or assessment. During the student lesson/test interaction, performance data is collected in real-time and temporarily stored in the computer's working memory. Process 400 may be performed as a set frequency during the interaction, or once at the end of the lesson/test. The process 400 begins at a start state 402 and then moves to a state 404 wherein keyboard monitoring is begun by receiving, storing and time-stamping initial keyboard input to the teaching system 100. The process 400 then moves to a state 406 wherein mouse movement during the lesson or assessment is passively tracked by receiving, storing and time-stamping an initial mouse movement input setting. The process 400 then moves to a state 408 wherein the teaching system 100 begins tracking the student's eye movement in order to determine how much the student is paying attention during the lesson or assessment.

The process 400 then moves to a state 410 wherein a microphone within the teaching system 100 is activated in order to record any oral input from the student during the lesson or assessment. The process 400 then moves to a state 412 wherein the student's answers to questions posed during the assessment are received, stored and time-stamped within the system 100.

The process 400 then moves to a state 416 wherein the response time that a student has in answering questions during an assessment are recorded and stored to the system 100. The process 400 then moves to a state 418 wherein the amount of time a student observes a particular lesson, or assessment page, is determined and stored within the system 100.

The process 400 then moves to a state 420 wherein the amount of time a student spends on the total lesson or assessment is determined and stored to the system 100. Next, at a state 422, the various page elements and sequence of selections made by the student are determined and stored within the system 100. The process 400 then moves to a state 424 wherein the sequence of pages viewed during the lesson or assessment is determined and stored within the system 100. The process 400 then terminates at an end state 426.

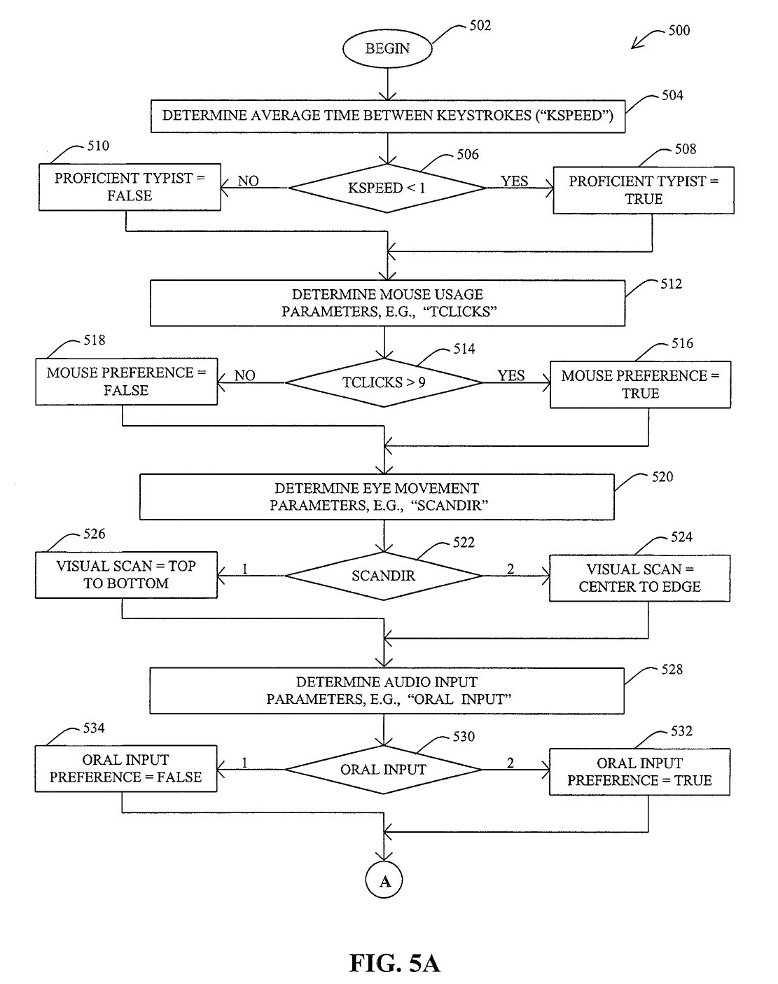

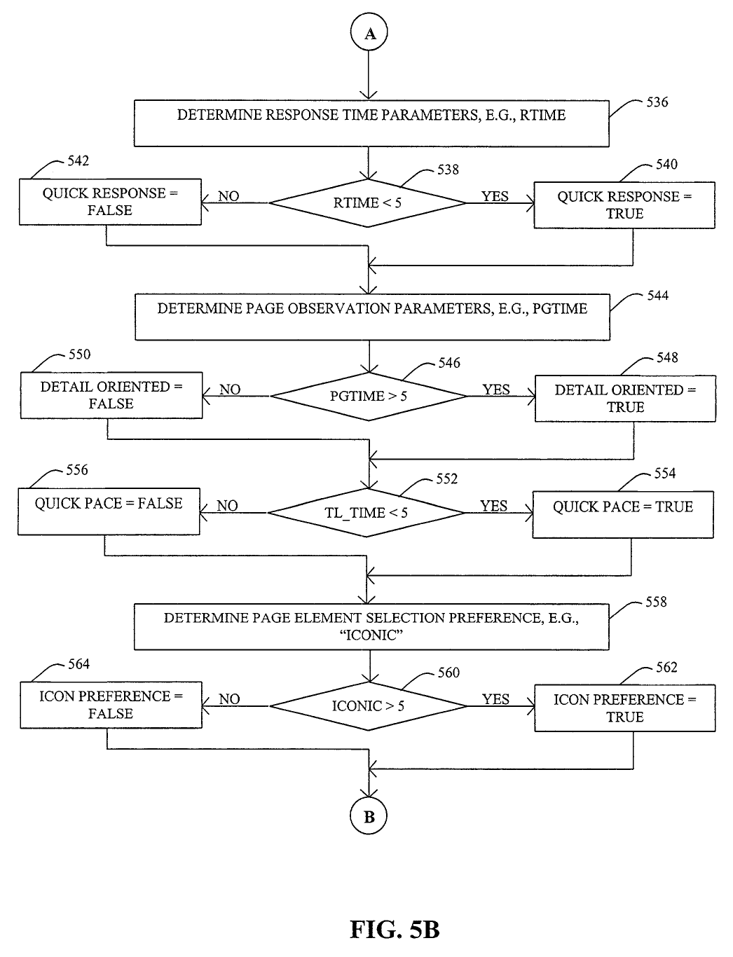

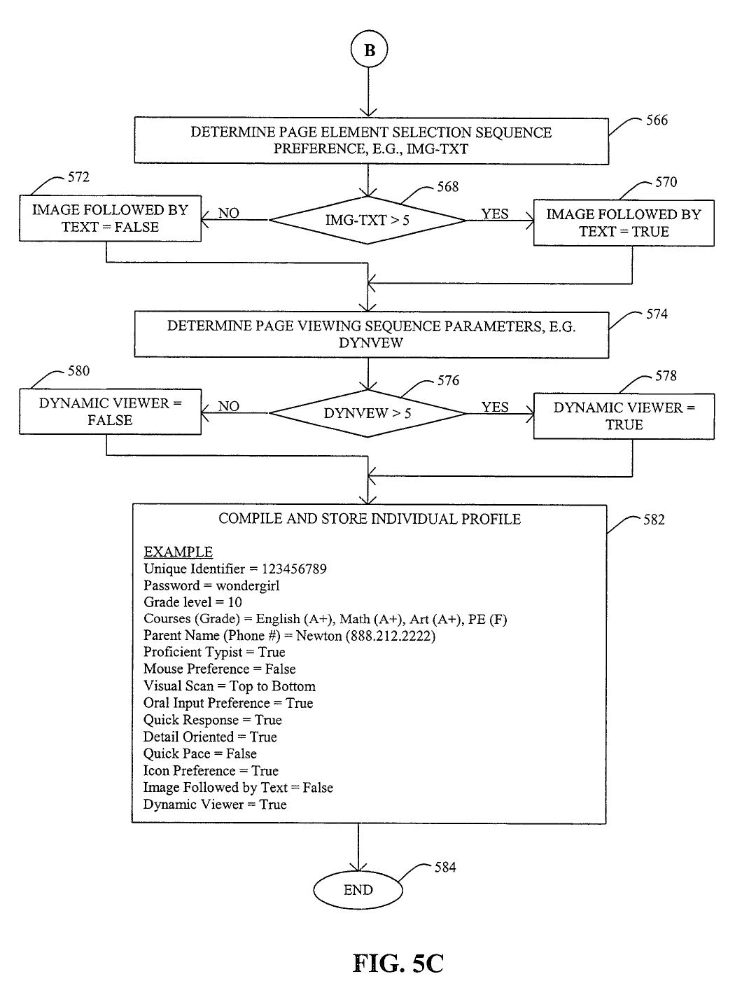

Referring now to FIGS. 5A to 5C, a process 500 for compiling and storing an individual profile using passive data collection during a lesson or assessment is illustrated. The process 500 begins at a start state 502 and then moves to a state 504 wherein the average time between keystrokes is determined. A determination is then made at a decision state 506 whether the keystroke speed is less than 1 second, for example. If the keyboard speed is determined to be less than 1 second, the process 500 moves to a state 508 wherein a value is set indicating that the student is a proficient typist. However, if a determination is made that the average time between keystrokes is greater than 1 second, a determination is made at a state 510 that the student is not a proficient typist. It will be apparent to a person of ordinary skill in the relevant technology that the condition value for keystroke speed may be set at a number of different, appropriate values. For example, depending on the student's age, the keystroke speed condition may be preferably approximately 0.5 seconds, more preferably about 1.0 seconds, and most preferably about 1.5-2.0 seconds.

Following the keystroke speed determination, the process 500 moves to a state 512 wherein the number of mouse clicks, or selections, is determined. The process 500 then moves to a decision state 514 to determine whether the number of mouse clicks during the lesson was greater than or less than 9. Of course, it should be understood that embodiments of the invention are not limited to a particular number of mouse clicks. Rather, the invention relates to measuring the number of mouse clicks during a particular period of time. If a determination is made that the total number of mouse clicks during the lesson or assessment is greater than 9, a value is set at a state 516 indicating that the student has a preference for using a mouse. However, if the number of mouse clicks during a particular period of time is less than 9, the process 500 moves to a state 518 wherein a value is set indicating that the student generally does not prefer to use the mouse for input.

Process 500 then moves to a state 520 in order to determine the eye movement pattern of the student during the lesson or assessment. The process 500 then moves to a decision state 522 to determine what type of visual scan the student generally uses. hi one embodiment, for example, if at a state 522 the system determines that the student's visual scan pattern is of level or type “1,” then the student generally employs a top-to-bottom visual scan of a display screen displayed to the student. If, however, at the state 522 the system determines that the student's visual scan pattern is of level or type “2,” then the student generally employs a center-to-edge visual scan of the screen displayed to the student. The “SCANDIR” attribute is set accordingly and added to the student's behavioral profile.

Once the eye movement scan has been performed, the process 500 moves to a state 528 wherein audio input parameters for listening to the student's voice are determined. A decision is then made at a decision state 530 whether the student has a preference for oral input on lessons or assessments. If a determination is made that the student prefers oral input, the process 530 moves to a state 532 wherein an oral input preference value is set to true. However, if a determination is made that the student does not prefer oral input, the process 500 moves to a state 534 wherein a value of oral input preference is set to false. The process 500 then moves to a state 536 in order to determine the response time of the student during various interactive sessions with the teaching system 100.

A determination is then made at a decision state 538 whether the student's response time was quick or not. If a student's response time is determined to be quick at the decision state 538, the process 500 moves to a state 540 wherein a value for a quick response is set to true. However, if a determination is made at the decision state 538 that the student is not responding quickly to an assessment or lesson, the process 500 moves to a state 542 wherein a quick response value is set to false.

The process 500 then moves to a state 544 in order to determine page observation parameters during the lesson or assessment. If a determination is made at a decision state 546 that the student is more detail-oriented, the process 500 moves to a state 548 wherein a detail-oriented value is set to true. However, if a determination is made at the decision state 546 that the student is not detail-oriented, the process 500 moves to a state 550 wherein a detail-oriented value is set to false.

The process 500 then moves to a decision state 552 to determine whether the amount of time spent on a particular page is greater than a prechosen number. For example, the time spent on a particular page might be 5, 10, 15, 20 or more seconds. In this embodiment, if a determination is made that the time spent on a page is less than 5 seconds, the process 500 moves to a state 554 and sets a “quick pace” value to true, indicating that the student observes pages in a lesson at a quick pace. However, if a determination is made at the decision state 552 that the time viewing each page is greater than 5, the process 500 moves to a state 556 wherein the “quick pace” value is set to false.

The process 500 then moves to a state 558 wherein the student's preference for icons on a page is determined. At a decision state 560, a determination is made whether the student has a preference for icons by measuring the number of icons selected by the student while a particular page in a lesson is being viewed. If a determination is made that the number of icons is greater than 5, a value is set at a decision state 562 indicating that the student has a preference for learning using icons. However, if a determination is made at the decision state 560 that the student does not select a specific number of icons, the process 500 moves to a state 564 wherein a value is set to false indicating that the student does not select a predetermined number of icons while viewing a page. The process 500 then moves to a state 566 to determine the type of page element preferred by the student. Page elements are structures such as text, graphics, images, videos, sounds or other mechanisms, for providing lessons and assessments to a student.

A determination is made at a decision state 568 whether the student prefers to see images followed by text describing the image. If a determination is made that the student does prefer images followed by text, a value reflecting this is set at a state 570. However, if a determination is made at the decision state 568 that the student does not prefer images followed by text, a value reflecting this is set at a state 572. The process 500 then moves to a state 574 to determine page viewing sequence parameters for the student. If a determination is made at a decision state 576 that the student prefers a dynamic viewer, the process 500 moves to a state 578 to set a value indicating the student prefers dynamic viewers. However, if the student does not prefer a dynamic viewer, the process 500 moves to a state 580 wherein a value is set indicating that the student does not prefer a dynamic viewer. The process 500 then moves to a state 582 to compile and store an individual profile for the student. The individual profile would include the values described above in relation to FIG. 5A-C in addition to other profile information on the student, such as their name, address, telephone number, etc. The process 500 then terminates at an end state 584.

A person of ordinary skill in the art will recognize that the condition values discussed above with reference to FIGS. 5A-C and associated with decision states 506, 514, 522, 530, 538, 546, 552, 560, 568, and 576 are only illustrative. The actual condition value may be chosen to suit a specific application or student population. Similarly, the outcome states associated with each of these decision blocks need not be limited to the states described above, which are merely exemplary. In some embodiments, the outcome states may number 1, 2, 3, or many.

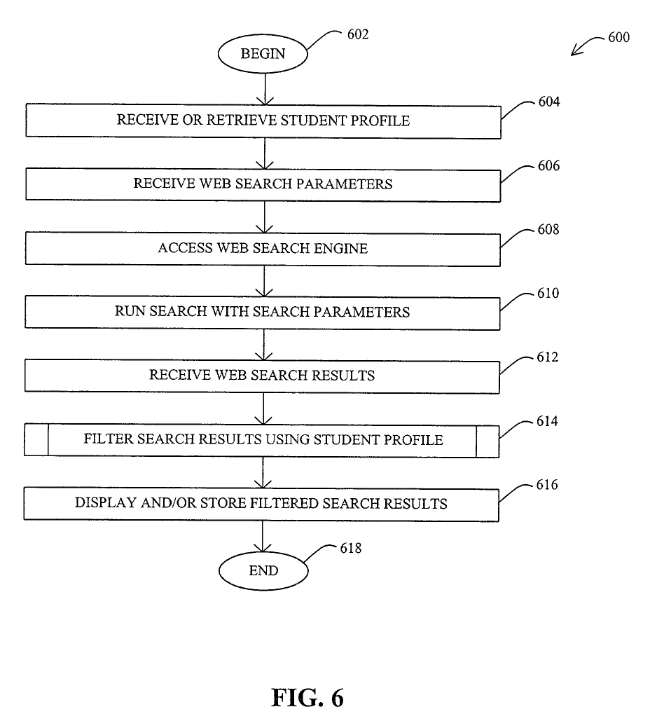

Referring now to FIG. 6, a process 600 for displaying and storing filtered search results using a generated profile is explained. The process 600 begins at a start state 602 and then moves to a state 604 wherein a student (or student) profile is received or retrieved from the teaching system 100. The process 600 then moves to a state 606 wherein web search parameters are received from an Internet interface. The web search parameters might be, for example, search terms used to search and retrieve information on a particular subject on the Internet. Well-known search engines includes those by Yahoo, Google, Netscape and many others. Once the web search parameters have been received by the system at the state 606, the process 600 accesses a web search engine at a state 608 and runs the requested search at a state 610 in order to retrieve the search results. The process 600 moves to a state 612 wherein the search results from the requested Internet search are received by the teaching system 100. The process 600 then moves to a process state 614 in order to filter the results searched with the data stored in the student profile. Thus, the student's profile can be used to only present information to the student in a format that is acceptable based on the parameters stored in their student profile. Once the results are received at the state 614, the process 600 moves to a state 616 wherein the filtered search results are displayed and/or stored to the student. The process 600 then terminates at an end state 618.

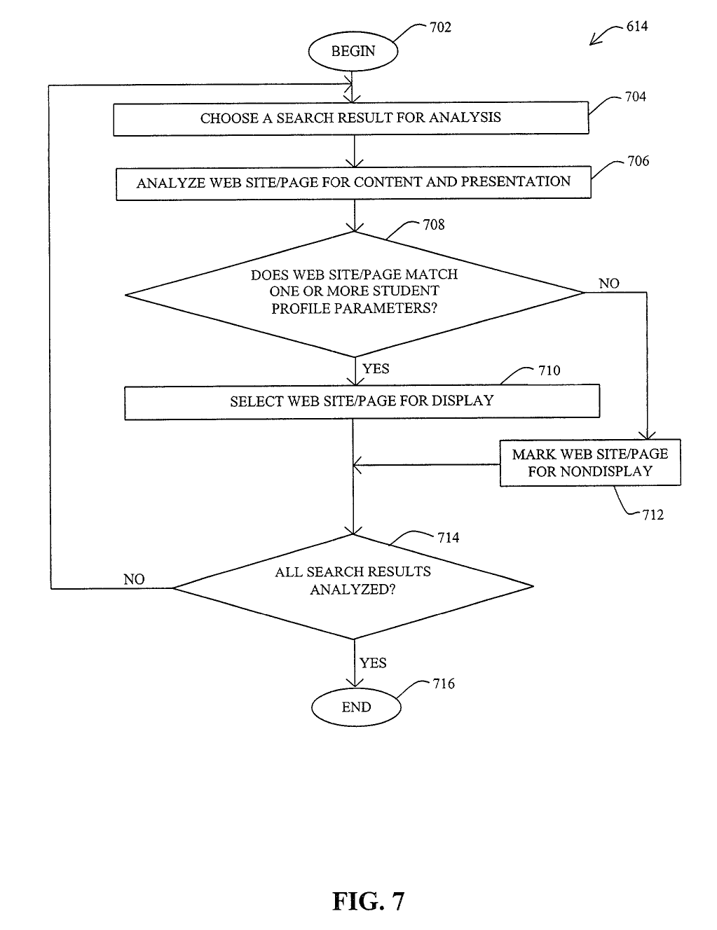

Referring now to FIG. 7, the process 614 for filtering search results using a student profile is explained. The process 614 begins at a start state 700 and then moves to a state 704 wherein a first search result is selected for analysis. The process 614 then moves to a state 706 wherein the web site returned by the search is analyzed for its content and presentation. A determination is then made at a decision state 708 whether the returned web site or web page matches one or more student profile parameters stored in the student's profile. If a determination is made that the web site does match one or more parameters of the student's profile, the process 614 moves to a state 710 wherein the web site or page is selected for display. However, if the retrieved web site does not match one or more parameters of the student's profile, the process 614 moves to a state 712 wherein the web site is marked to not be displayed to the student. The process 614 then makes a determination at a decision state 714 wherein all search results have been analyzed. If the search results have not all been analyzed, the process 614 returns to the state 704 in order to choose a next search result for analysis. However, if a determination is made that all the search results have been analyzed, the process 614 terminates at an end state 716.

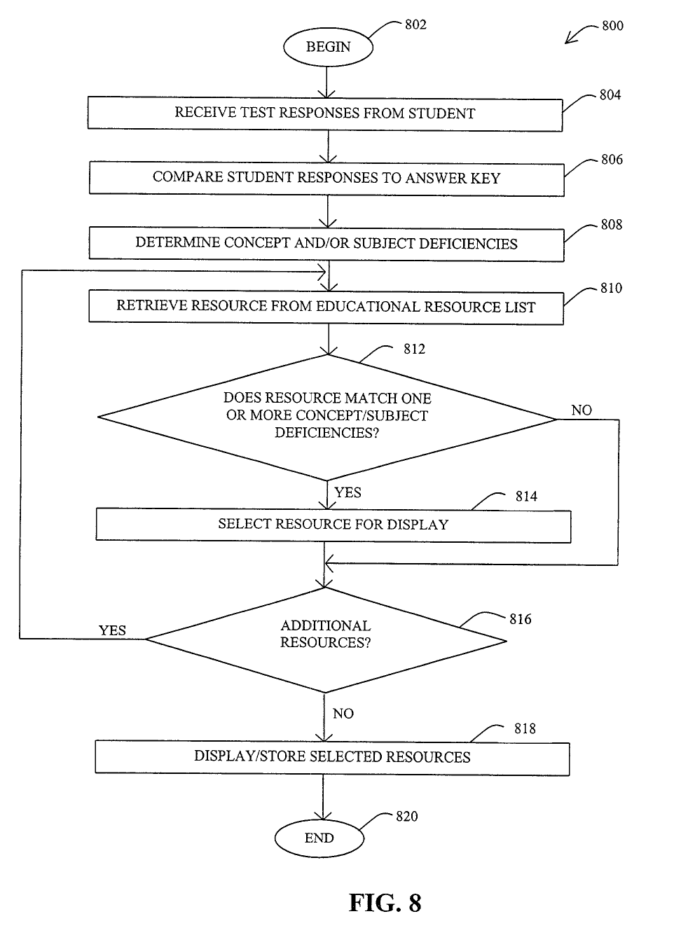

Referring now to FIG. 8, a process 800 for displaying or storing selected resources is described. The process 800 begins at a start state 802 and then moves to a state 804 wherein test responses are retrieved from a student. At a state 806 the test responses from the student are compared to an answer key. The process 800 then moves to a state 808 wherein the concepts or subject matter deficiencies revealed from matching the student's responses to the answer key are determined. The process 800 then moves to a state 810 in order to retrieve resource information from an educational resource list, such as an encyclopedia, thesaurus or other well-known educational resource.

A determination is then made at a decision state 812 whether the retrieved resource matches one or more of the concept or subject matter deficiencies indicated from the student's responses. If the resource does match, the process 800 moves to a state 814 in order to select that resource for display to the student. However, if the resource does not match one or more of the subject matters identified as being deficient, the process 800 moves to a decision state 816 to determine whether additional resources are available. If additional resources are available, the process 800 returns to the state 810 to retrieve additional resources from the educational resource list. However, if additional resources are not available, the process 800 moves to a state 818 and displays or stores the resources that have so far been selected for the student. The process 800 then terminates at an end state 820.

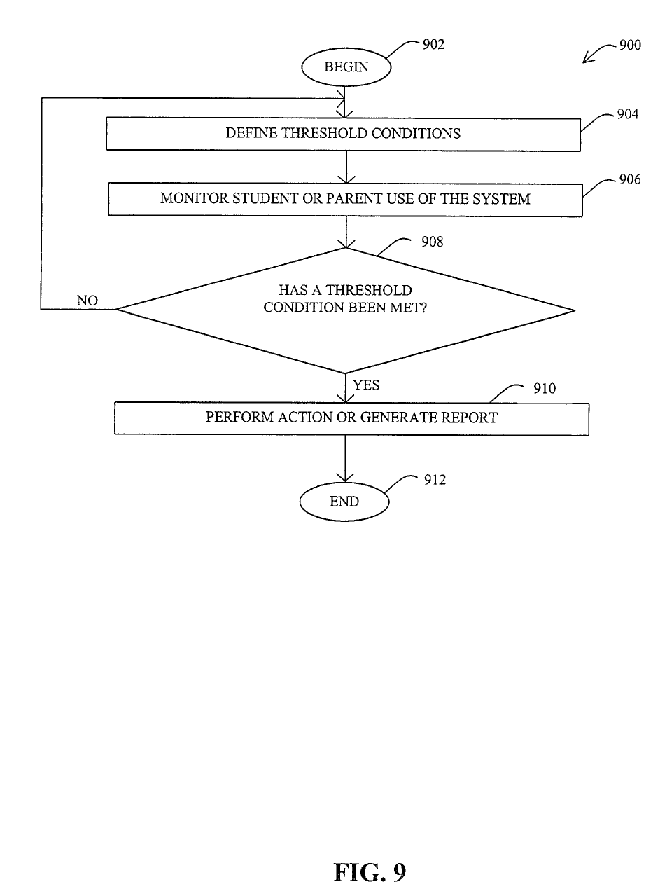

Referring now to FIG. 9, a process 900 for performing an action or generating a report is illustrated. This process is run at a preset frequency, for instance, once per day. Or, the process may be run at any time by an educator. The process 900 begins at a start state 902 where educators may define threshold conditions at a state 904. Once the threshold conditions have been defined, the process 900 moves to a state 906 wherein student interaction with the teaching system 100 is monitored. The process 900 then moves to a decision state 908 to determine whether a threshold condition has been met. If a threshold condition has not been met, the process 900 returns to the state 904 to define further threshold conditions. However, if a threshold condition has been met at the decision state 908, the process 900 moves to a state 910 wherein a threshold action is performed or a report is generated based on the threshold condition that was met. The process 900 then terminates at an end state 912.

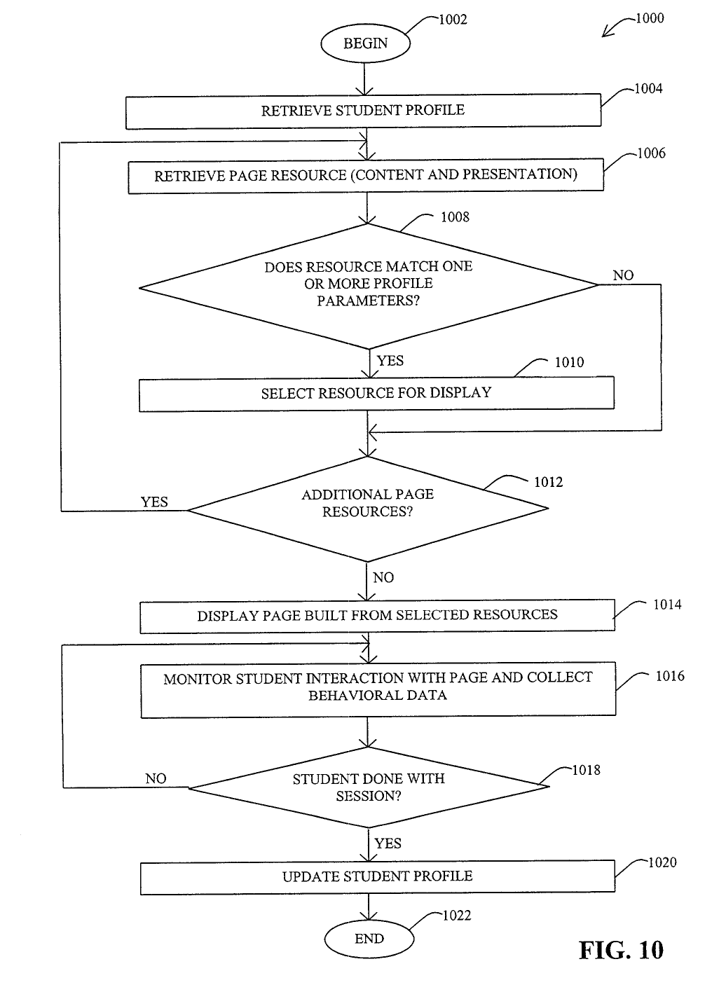

Referring now to FIG. 10, a process 1000 for updating a student's profile is illustrated. The process 1000 begins at a start state 1002 and moves to a state 1004 wherein a student's profile is retrieved. Once the student's profile has been retrieved into the teaching system 100, the process 1000 moves to a state 1006 and retrieves page resources, such as content and presentation. A determination is then made at a decision state 1008 of whether the retrieved resource matches one or more of the parameters in the student's profile. If the resource does match one or more parameters, the resource is selected for display to the student at a state 1010. However, if the resource does not match one or more of the student's profile parameters, the process 1000 moves to a decision state 1012 to determine if additional page resources are available.

If additional page resources are available, the process 1000 returns to the state 1006 in order to retrieve additional page resources. However, if a determination is made at the decision state 1012 that additional pages are not available, the process 1000 moves to a state 1014 in order to display a page built from the selected resources. The process 1000 then moves to a state 1016 to monitor the student's interaction with the page and to collect passive behavioral data from the student. As the student's interaction is being monitored, a determination is made at a decision state 1018 whether the student is done with the current session. If the student is not done, the student's interaction is continually monitored at the state 1016. However, if the student is finished with the session, the process 1000 moves to a state 1020 and updates the student's profile with new information gleaned from the interactions monitored at the state 1016. The process 1000 then terminates at a state 1022.

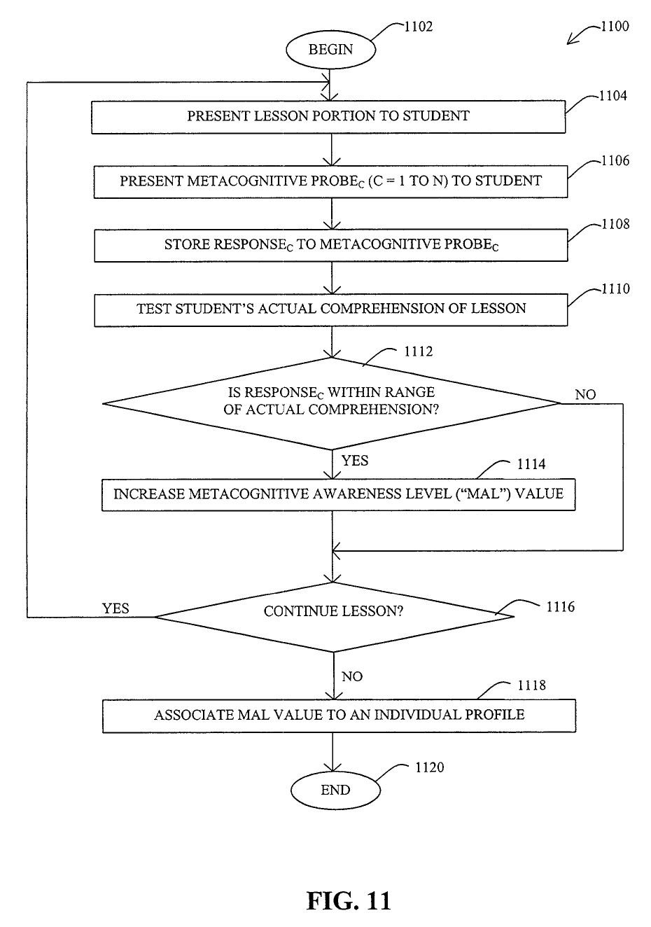

Referring now to FIG. 11, a process for associating a metacognitive awareness level (MAL) value to an individual profile is illustrated. This MAL value may be determined and stored as part of the student profile and is optionally included in a lesson/test. The process 1100 begins at a start state 1102 and moves to a state 1104 wherein a portion of a lesson is presented to a student. A metacognitive probe is then presented to the student at a state 1106. The metacognitive probe is typically designed to request the student's estimate of their own metacognitive awareness level in order to later compare their awareness with their actual metacognitive skills. Thus, the process 1100 moves to a state 1108 wherein the student's response to the metacognitive probe is stored.

Following storage of the metacognitive probe data, the process 1100 tests the student's actual comprehension of the lesson portion at a state 1110. A determination is then made at a decision state 1102 whether the student's actual comprehension of the lesson portion matched the response made by the student to their metacognitive probe at the state 1108. If the response is within the range, the process 1100 moves to a state 1114 wherein the metacognitive awareness level of the student is increased to indicate that they are very aware of their metacognitive state. However, if the stored response from the student is not within the range of actual comprehension from the test results, the process 1100 moves to a decision state 1106 to determine whether a lesson should be continued. If the lesson should be continued, the process 1100 returns to the state 1104 to present additional lessons to the student. However, if a determination is made to not continue the lesson at the state II l6, the process 1100 moves to a state 1118 wherein the metacognitive awareness level of the student is added to the student's individual profile to indicate their metacognitive awareness. The process 1100 then terminates at an end state 1120.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The scope of the invention is indicated by the appended claims rather than by the foregoing description. All changes which come within the meaning and range of equivalency of the claims are to be embraced within their scope.

What is claimed is:

1. A method of creating a behavioral profile of a student in a computerized teaching system, comprising:
displaying to the student a plurality of interactive computer screen displays associated with a lesson or an assessment;
receiving passive data from monitoring an input on the computer;
determining an attribute of the student's learning ability based on the received passive data; and
storing the determined attribute to a student behavioral profile to a storage associated with the teaching system.

2. The method of claim 1, wherein the input is a keyboard entry and the passive data is collected by determining an average typing speed of the student.

3. The method of claim 1, wherein the input is a mouse, and the passive data is collected as mouse movements.

4. The method of claim 1, wherein the passive data is the average time period that the student takes to view one of the plurality of screen displays.

5. The method of claim 1, wherein displaying to the student a plurality of interactive screen displays comprises displaying multi-media elements.

6. The method of claim 5, wherein the passive data comprises the frequency that the student selects the associated multi-media elements, and determining the student's preference for a particular type of multimedia element.

7. The method of claim 6, further comprising assigning one or more multi-media element preference attributes to the behavioral profile.

8. The method of claim 1, further comprising determining a metacognitive awareness level of the student, and assigning a metacognitive awareness attribute to the behavioral profile based on the student's awareness level.

9. A computerized teaching system comprising a computer having a display and an input, comprising:
a computer monitor connected to the computer, wherein the monitor displays a plurality of interactive computer screens associated with a lesson or a test;
a first module configured to receive passive data by monitoring the input connected to the computer over a predetermined period of time;
a second module configured to determine an attribute of the student's learning ability based on the received passive data; and
a third module configured to store the determined attribute to a student behavioral profile to a storage associated with the teaching system.

10. The system of claim 9, wherein the input is a mouse, and the passive data is collected as mouse movements.

11. The system of claim 9, wherein the passive data is the average time period that the student takes to view one of the plurality of screen displays.

12. The system of claim 9, wherein the interactive screens display multi-media elements.

13. The system of claim 12, wherein the passive data comprises the frequency that the student selects the associated multi-media elements.

14. A method of using a behavioral profile for adapting the content or form, or both, of a presentation, the method comprising:
defining one or more behavioral profile classifications, wherein the classifications are associated with selected ones of a plurality of content and form resources of a presentation;
constructing a behavioral profile of a student, wherein the behavioral profile comprises a plurality of attributes, and wherein constructing comprises:
displaying to the student a plurality of interactive screen displays associated with a lesson or a test, or both;
receiving input from the student at a computing device, wherein the input comprises keyboard entries and pointer movement;
determining a pointer movement pattern of the student and based thereon assigning a pointer movement attribute to the behavioral profile;
determining an average time period that the student takes to answer questions presented to the student via the interactive screen displays, and based thereon assigning a response time attribute to the behavioral profile;
determining a sequence of interactive screen displays chosen by the student while taking the lesson or test, or both, and based on the sequence assigning a navigational attribute to the behavioral profile; and
storing the behavioral profile at a memory of the computing device; associating at least one of the one or more behavioral profile classifications to the behavioral profile of the student; and
selecting for display to the student one or more content or form resources associated with the profile classification corresponding to the behavioral profile of the student.

15. The method of claim 14, wherein selecting for display to the student one or more content or form resources comprises selecting content or form resources retrieved by a web search, wherein the web search is performed using a web search engine.
